(19) United States
(12) Patent Application Publication
(10) Pub. No.: US 2019/0329377 A1
(43) Pub. Date: Oct. 31, 2019

(54) MULTI-AXIS POLISHING APPARATUS

(71) Applicants: Hsi-Chih KUO, Taoyuan City (TW); HUNG FU DEVELOPMENT CO., LTD., Taoyuan City (TW)

(72) Inventors: Hsi-Chih KUO, Taoyuan City (TW); Jhe-Kai KUO, Taoyuan City (TW); Wei-Chun LIN, Taoyuan City (TW)

(21) Appl. No.: 16/393,222

(22) Filed: Apr. 24, 2019

(30) Foreign Application Priority Data
Apr. 25, 2018 (TW) 107114056

(51) Int. Cl. B24B 41/00; B23Q 1/64; B24B 41/02; B24B 27/00; B24B 41/06; B24B 47/22

(52) U.S. Cl. CPC B24B 41/005; B23Q 1/64; B24B 41/02; B24B 47/22; B24B 27/0076; B24B 41/06; B24B 41/002

(57) ABSTRACT

A multi-axis polishing apparatus includes a machine body, a multi-axis transmission device, and an abrasive container set. The multi-axis transmission device, movably mounted onto a main vertical column in a machine body that can move in an insertion direction, includes a driving module and a plurality of shaft assemblies connected transmissively to the driving module. The plurality of shaft assemblies is used to mount a plurality of workpieces, respectively. The abrasive container set, located below the multi-axis transmission device, is filled with abrasive materials. The multi-axis transmission device moves in the insertion direction to position the plurality of shaft assemblies as well as the plurality of workpieces downward into the abrasive container set, and then the driving module rotates the plurality of shaft assemblies and the plurality of workpieces to utilize the abrasive materials to polish the plurality of workpieces.

This application claims the benefit of Taiwan Patent Application Serial No. 107114056, filed on Apr. 25, 2018, the subject matter of which is incorporated herein by reference.

### BACKGROUND OF THE INVENTION

### 1. Field of the Invention

The invention relates to a multi-axis polishing apparatus, and more particularly to the multi-axis polishing apparatus that implements a driving module to rotate a plurality of shaft assemblies and workpieces to conduct polishing actions.

### 2. Description of the Prior Art

Generally speaking, while in manufacturing metallic or nonmetallic parts, cutting and trimming steps to reach final geometric dimensions and profiles are inevitable. Thus, managing surface roughness to a desired fine level on such parts is definitely an issue. Taking metallic parts as examples, in order to improve surface finish of the metallic parts, a final polish or a combination of grinding and polishing process is usually introduced to remove all possible sharpness and rough texture over the part surfaces, particularly at the edges and important stress bearing or decorating surfaces.

As mentioned, current polishing technique utilizes mainly a polisher and the like apparatus for polishing. However, since these polishers can only process a single workpiece at a unique polish step for parts having complex geometry or contours, thus it is obvious that the production rate for such parts would be limited. Even that an automated process or machine is introduced to increase the production rate, yet due to the limitation of one workpiece per each polisher, the improvement is limited. Hence, the resulted increase in the production rate for such parts is still far from satisfactory.

### SUMMARY OF THE INVENTION

In view that the conventional competing active polisher for processing complex surfaces simultaneously is limited to process only one workpiece each time, thus the production rate can't be effectively increased; therefore, the production cost is kept relatively high. Accordingly, an object of the present invention is to provide a multi-axis polishing apparatus that can process multiple parts simultaneously in one manufacturing step.

In present invention, the multi-axis polishing apparatus includes at least a machine body, a multi-axis transmission device, and an abrasive container set. The multi-axis transmission device, mounted onto a moving mechanism in a main vertical column of the machine body that can move up and down along a vertical track, includes a driving module and a plurality of rotatable shaft assemblies that are transmissively linked to the driving module. The plurality of shaft assemblies are used to mount a plurality of workpieces, respectively. The abrasive container set, located below the multi-axis transmission device, can be filled with abrasive materials. The multi-axis transmission device moves along the vertical track to position the plurality of shaft assemblies as well as the plurality of workpieces downward into the abrasive container set, and then the driving module rotates the plurality of shaft assemblies and the plurality of workpieces to utilize the free moving granular abrasive materials to polish the plurality of workpieces.

In one embodiment of the present invention, each of the plurality of shaft assemblies includes a shaft sub-assembly, a gear disk, and a transmission member. The gear disk is fixed to individual shaft sub-assembly. The transmission member links the gear disk and the driving module to drive shaft assembly.

Preferably, the driving module includes a motor, a driving shaft, and a plurality of outer ring gears which are individually fixed to the driving shaft in a parallel arrangement. Each of the plurality of outer ring gears links to the corresponding gear disk of the respective shaft assembly via the transmission member. In addition, each of the shaft sub-assembly includes a shaft body and an engagement member. Each of the shaft bodies is firmly mounted with a gear disk; the engagement member is also rigidly connected to a shaft body; the engagement member is used for mounting a connection arm; and the connection arm is used for mounting at least one workpiece.

In one embodiment of the present invention, the abrasive container set includes a plurality of container spaces filled individually with respective sets of the abrasive materials, and the sets of the abrasive materials may have respective (i.e., different) combinations of grit sizes of the abrasive materials. Thereupon, various types or levels of polishing can be performed simultaneously or sequentially via these container spaces.

As stated above, the multi-axis polishing apparatus described by this invention utilizes the driving module to rotate a plurality of rotational members for effectively polishing a plurality of workpieces simultaneously. In addition, by arranging or partitioning the whole container space of the abrasive container set in accordance with the present invention, different manufacturing processes may be performed simultaneously.

All these objects can be achieved by the multi-axis polishing apparatus described below.

### BRIEF DESCRIPTION OF THE DRAWINGS

The present invention will now be specified with reference to its preferred embodiment illustrated in following drawings, in which:

FIG. 1 is a schematic perspective view of a preferred embodiment of the multi-axis polishing apparatus in accordance with the present invention;

FIG. 2 shows another view of FIG. 1;

FIG. 3 is a schematic perspective view of the driving module and the shaft assemblies of FIG. 1;

FIG. 4 demonstrates schematically connection of the driving module and shaft assemblies of FIG. 3, and workpieces;

FIG. 5 illustrates schematically another aspect of FIG. 1 loaded with the workpieces; and partially filled with abrasive materials in the abrasive container set;

FIG. 6 demonstrates schematically another state of FIG. 5 with the multi-axis transmission device being lowered in an insertion direction to dip the workpieces into the abrasive container set;

FIG. 7 shows schematically a view that the workpieces are rotated by the driving module in the abrasive container set in accordance with the present invention;

FIG. 8 shows schematically a view that workpieces are rotated by a driving module in an abrasive container set of another embodiment of the multi-axis polishing apparatus in accordance with the present invention; and

FIG. 9 shows schematically a view that workpieces are rotated by a driving module in an abrasive container set of a further embodiment of the multi-axis polishing apparatus in accordance with the present invention.

### DESCRIPTION OF THE PREFERRED EMBODIMENT

The invention disclosed herein is directed to a multi-axis polishing apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

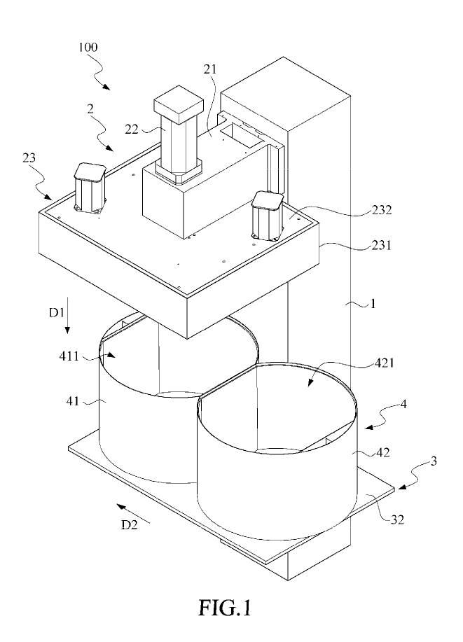

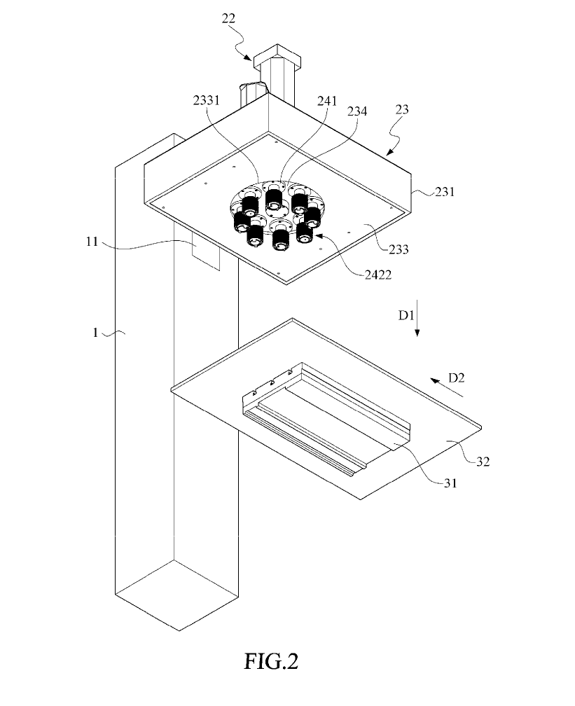

Refer to FIG. 1 and FIG. 2 now; where FIG. 1 is a schematic perspective view of a preferred embodiment of the multi-axis polishing apparatus in accordance with the present invention; and FIG. 2 shows another view of FIG. 1. As shown, the multi-axis polishing apparatus 100 includes a main vertical column 1 in a machine body, a multi-axis transmission device 2, a movable material-carrying table set 3, and an abrasive container set 4. The main vertical column 1 in the machine body is furnished with a vertical lifting track 11 extending in an insertion direction D1.

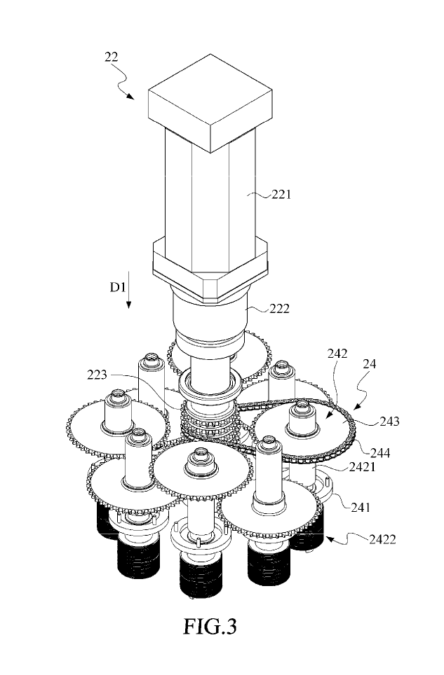

The multi-axis transmission device 2 includes a co-moving linkage 21, a driving module 22, a transmission housing 23, and eight shaft assemblies 24 (one labeled in FIG. 3). The co-moving linkage 21 is movably mounted to the lifting track 11, so that the multi-axis transmission device 2 can be moved in the insertion direction D1 along the main vertical column 1. In this embodiment, with the co-moving linkage 21 mainly having motors and related power elements installed there inside to move back and forth along the lifting track 11 in the insertion direction D1, the multi-axis transmission device 2 can thus be placed at any target position in the insertion direction D1 with respect to the machine body. However, the present invention is not limited to the foregoing design. In another embodiment not shown here, an engagement structure can be introduced to fix the co-moving linkage 21 with the lifting track 11, so that the movement of the lifting track 11 itself in the insertion direction D1 can directly re-position the co-moving linkage 21.

Referring also to FIG. 3, a schematic perspective view of the driving module and the shaft assemblies of FIG. 1 is presented. As shown, the driving module 22 includes a driving motor 221, a driving shaft 222, and eight outer ring gears 223 (one labeled in the figure). The driving motor 221 is firmly mounted at the co-moving linkage 21, and the driving shaft 222 is transmissively connected to the driving motor 221 so as to be rotated by the driving motor 221. These eight outer ring gears 223 are rigidly and parallelly assembled onto driving shaft 222 in its axial direction.

The transmission housing 23 includes an outer frame 231, a top plate 232, a bottom plate 233, and a positioning turn-plate 234. The top plate 232 is firmly secured to top of the outer frame 231, and the co-moving linkage 21 is firmly connected to the top plate 232. The bottom plate 233 is firmly secured to bottom of the outer frame 231 and is furnished with an opening 2331. The positioning turn-plate 234, that can rotate shaft assemblies, is mounted through the opening 2331.

The eight shaft assemblies 24 are evenly positioned to surround the driving shaft 222 along a circular line. Each of the shaft assemblies 24 includes a locating bearing 241, a shaft sub-assembly 242, a gear disk 243, and a transmission member 244.

The locating bearings 241 are mounted onto the positioning turn-plate 234. The shaft sub-assembly 242 includes a shaft body 2421 and an engagement member 2422. The shaft body 2421 is mounted into its respective locating bearing 241 so as to space the driving shaft 222 by a fixed distance. This arrangement allows the shaft body 2421 to rotate controllably via the rotation of driving shaft 222. The total eight shaft bodies 2421 of the eight corresponding shaft assemblies 24 are evenly arranged around the driving shaft 222, and each of the shaft bodies 2421 is spaced from the driving shaft 222 by an identical distance.

The engagement member 2422, fixed to the lower end of respective shaft body 2421, is positioned below the locating bearing 241. Therefore, with a lower portion of the shaft body 2421 penetrating through locating bearing 241 and the positioning turn-plate 234, the engagement member 2422 can thus be exposed below the transmission housing 23. The gear disk 243 is rigidly fixed to respective shaft body 2421, is to transmissively engage the corresponding outer ring gear 223 via the transmission member 244, so that the driving motor 221 can drive each of the shaft bodies 2421 via the corresponding combined motions of the driving shaft 222, the outer ring gear 223, and the gear disk 243. In this embodiment, the diameter of the driven gear disk 243 is larger than that of the driving outer ring gear 223. Therefore, as the driving shaft 222 and outer ring gear 223 rotates at a higher speed, the shaft body 2421 driven by the gear disk 243 would be rotated at a speed lower than that of the driving shaft 222. With this arrangement, a larger torque can be provided by the shaft body 2421. Practically, with designing a specific gear ratio of the outer ring gear 223 to the gear disk 243, an expected torque output from the shaft body 2421 can be obtained.

As described, the transmission member 244 in this example is embodied as a chain. However, in some other embodiments, the transmission member 244 can also be a belt or any other likewise functional object. In addition, in this embodiment, since all the eight shaft assemblies 24 are similarly structured, the only difference is that each of the gear disks 243 has its own installation height position in the shaft sub-assembly 242.

The material-carrying table set 3, located under the multi-axis transmission device 2, includes a driven end 31 and a carrying platform 32. The carrying platform 32, mounted fixedly on the driven end 31, is co-moved with the driven end 31 to displace reciprocally in a horizontal direction D2 which is perpendicular to the insertion direction D1. In this embodiment, the driven end 31 is part of a conveying belt device that has a conveying belt to move the carrying platform 32.

The abrasive container set 4, constructed on top of the carrying platform 32 so as to locate under the multi-axis transmission device 2, includes a first material tank 41 and a second material tank 42. The first material tank 41 has a first container space 411, and similarly the second material tank 42 has a second container space 421. The container spaces can either be in circular or noncircular forms. In this embodiment, both of the first container space 411 and the second container space 421 are non-circular spaces.

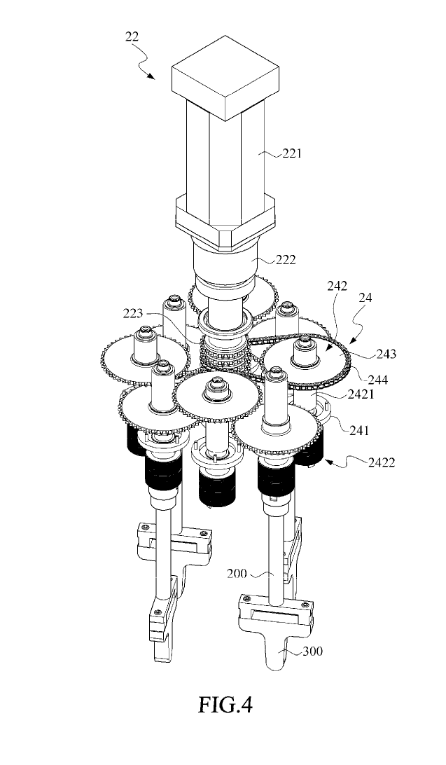

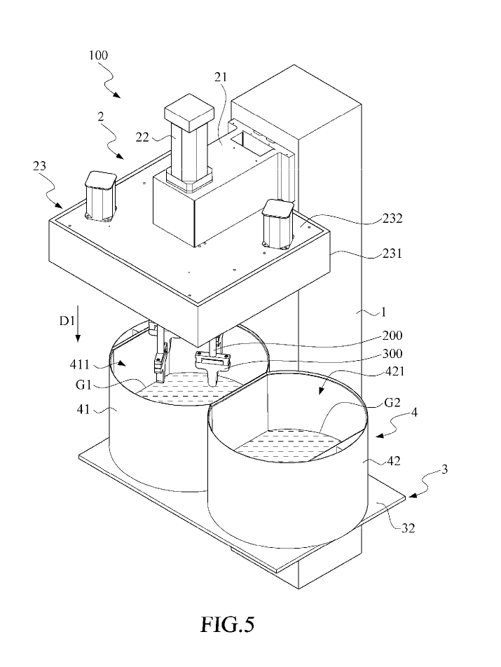

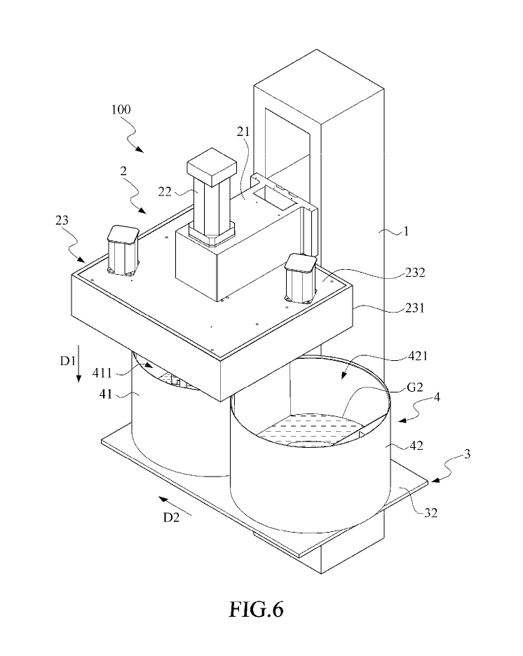

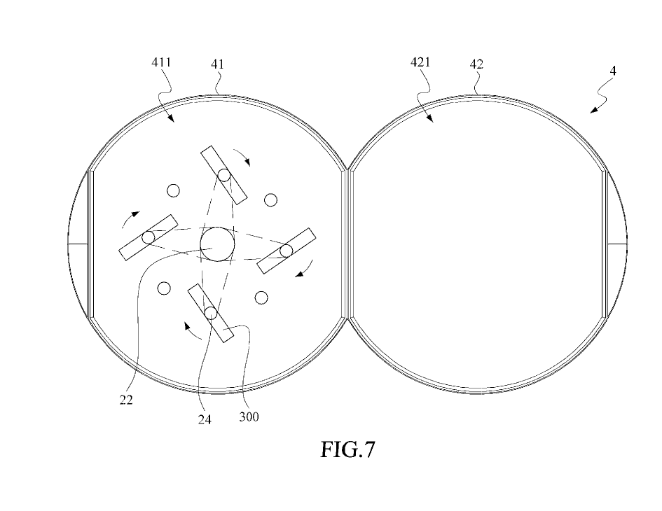

Refer to FIG. 4 to FIG. 7 now. FIG. 4 demonstrates schematically the connection of shaft assemblies of FIG. 3 and workpieces. FIG. 5 illustrates schematically another aspect of FIG. 1 loaded with the workpieces and filled with abrasive materials in the abrasive container set. FIG. 6 demonstrates schematically another state of FIG. 5 with the multi-axis transmission device being lowered in the insertion direction to dip the workpieces into the abrasive container set. FIG. 7 shows schematically a view of motion that the workpieces are rotated by the driving module in the abrasive container set in accordance with the present invention.

As shown in FIG. 4, in the case that four workpieces 300 (one labeled in the figure) are to be polished simultaneously, each of these four workpieces 300 is firstly mounted to one of the respective connection arms 200 (one labeled in the figure). Then, the connection arms 200 can be quickly mounted to the respective engagement members 2422, and thus the shaft sub-assemblies 242 can drive the respective workpieces 300. Thereupon, as the driving module 22 is activated, all workpieces 300 can be moved synchronously by the shaft sub-assembly 242.

As shown in FIG. 5 and FIG. 6, after the workpieces 300 are engaged with the driving module 22, the co-moving linkage 21 can drive the entire multi-axis transmission device 2 in the insertion direction D1 to a target position allowing the workpieces 300 to be dipped into the container space 411 that is filled with a set of granular abrasive materials G1.

As shown in FIG. 7, after the workpieces 300 are lowered into the container space 411, the driving module 22 can then be operated to rotate the shaft assemblies 24, so that the workpieces 300 can be rotated in the container space 411. At the same time, since the container space 411 is filled with the abrasive materials G1, thus the workpieces 300 can be ground/polished by the granular abrasive materials G1 so as to obtain desired smooth surfaces and texture.

In addition, since the abrasive container set 4 of this embodiment has a second container space 421 that is filled with another set of granular abrasive materials G2, thus, after the workpieces 300 are ground/polished to a target level by the abrasive materials G1 in the container space 411, the workpieces 300 can be further polished by the granular abrasive materials G2 in the container space 421. Practically, after the workpieces 300 have been polished by the abrasive materials G1 in the container space 411, the co-moving linkage 21 is activated to lift the entire multi-axis transmission device 2 upward in the direction D1 so as to retrieve the workpieces 300 from the container space 411; and then the driven end 31 as well as the carrying platform 32 are repositioned in the reciprocating direction D2 to align the container space 421 of the abrasive container set 4 on the carrying platform 32 directly below the multi-axis transmission device 2. At this time, the co-moving linkage 21 can move the entire multi-axis transmission device 2 in the insertion direction D1 to dip the workpieces 300 into the second container space 421. Subsequently, the driving module 22 is activated to rotate the workpieces 300 in the second container space 421, so that the workpieces 300 can be polished by the granular abrasive materials G2. Practically, the grit size of granular polishing materials of the first set of abrasive materials G1 is usually coarser than the grit size of granular polishing materials of the second set of abrasive materials G2. Therefore, the first set of abrasive materials G1 can be used to perform coarse polishing on the workpieces 300; and the second set of abrasive materials G2 can be used to perform fine polishing on the workpieces 300.

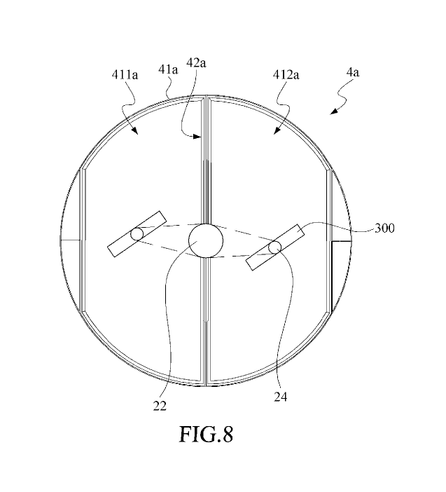

Referring now to FIG. 8, a view of the workpieces being rotated by the driving module in an abrasive container set of another embodiment of the multi-axis polishing apparatus in accordance with the present invention is schematically shown. In this embodiment, an abrasive container set 4a is introduced to replace the aforementioned abrasive container set 4. A difference between the abrasive container set 4a and the abrasive container set 4 is that the abrasive container set 4a includes only a material tank 41a. The material tank 41a is separated into two container spaces 411a and 412a by a partitioning plate 42a. In the case that only two sets of workpieces 300 are there to be polished, then these two sets of workpieces 300 can be assembled to form two symmetric shaft assemblies 24 so as to further connect to the driving module 22. In addition, the abrasive container set 4a can be mounted on a material-carrying set (not shown in the figure) having a rotational stroke for switching around the two container spaces 411a and 412a.

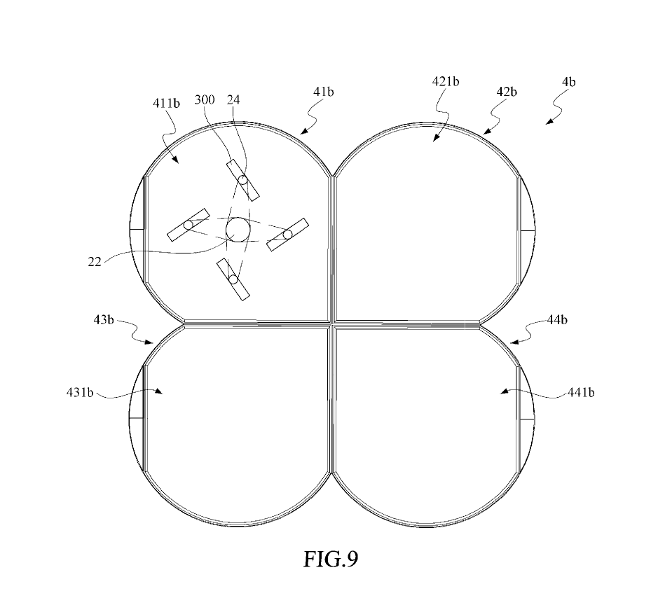

Referring now to FIG. 9, a schematic view of the workpieces being rotated by a driving module in an abrasive container set of a further embodiment of the multi-axis polishing apparatus in accordance with the present invention is shown. In this embodiment, an abrasive container set 4b can be introduced to replace the aforementioned abrasive container set 4. A difference between the abrasive container set 4b and the abrasive container set 4 is that the abrasive container set 4b includes four material tanks 41b, 42b, 43b and 44b. Thereupon, different sets of abrasive materials (not shown in the figure) can be filled individually into container spaces 411b, 421b, 431b and 441b of these four material tanks 41b, 42b, 43b and 44b, respectively. In addition, the abrasive container set 4b can be mounted on a material-carrying set (not shown in the figure) having a rotational stroke for switching the four container spaces 411b, 421b, 431b and 441b, such that four sets of workpieces 300 can be polished individually and simultaneously by rotating them in four respective sets of granular abrasive materials having different particle sizes.

In summary, in comparison with the conventional polishing of metallic parts with complex surfaces that can only handle one workpiece in each polishing step, thus leading to a low production rate and high production cost, the multi-axis polishing apparatus provided by this invention applies a driving module to rotate a plurality of rotational members for effectively and efficiently polishing a plurality of workpieces simultaneously. Furthermore, through adjusting the gear ratio between the outer ring gear and the gear disk as well as the rotational speed of the driving shaft, the output torque of the rotational members can be controlled. Thus, versatile workpieces can be processed simultaneously. In addition, by arranging or partitioning the whole container space of the abrasive container set in accordance with the present invention, different manufacturing processes can be performed simultaneously.

While the present invention has been particularly shown and described with reference to a preferred embodiment, it will be understood by those skilled in the art that various changes in form and detail may be constructed without departing from the spirit and scope of the present invention, and thus, should be treated as covered by this invention.

What is claimed is:

1. A multi-axis polishing apparatus, comprising:
a main vertical column;
a multi-axis transmission device, movably mounted onto the main vertical column that is positioned in an insertion/retraction direction, including:
a motor;
a driving module, including:
a driving shaft; and
a plurality of outer ring gears, mounted in a parallel arrangement onto the driving shaft in an axial direction; and
a plurality of shaft assemblies for mounting respectively a plurality of workpieces, each of the plurality of shaft assemblies including:
a shaft sub-assembly;
a gear disk, firmly mounted onto the shaft sub-assembly; and
a transmission member, transmissively linking the gear disk and the corresponding one of the plurality of outer ring gears, so that the each of the plurality of shaft assemblies is transmissively connected to the driving module; and
an abrasive container set, located under the multi-axis transmission device, that is filled with abrasive materials;
wherein, after the multi-axis transmission device moves in the insertion direction to lower the plurality of shaft assemblies and to dip the plurality of workpieces into the abrasive container set, the driving module rotates the plurality of shaft assemblies as well as the plurality of workpieces to utilize the abrasive materials to polish the plurality of workpieces.

2. The multi-axis polishing apparatus of claim 1, wherein each of the plurality of shaft sub-assemblies includes a shaft body and an engagement member, the gear disk is firmly mounted onto the shaft body, the engagement member is fixed to a lower end of the shaft body, the engagement member is used for mounting a connection arm, and the connection arm is used for mounting at least one of the plurality of workpieces.

3. The multi-axis polishing apparatus of claim 1, wherein the abrasive container set includes a plurality of container spaces, the plurality of container spaces are filled individually with respective sets of the abrasive materials, and the sets of the abrasive materials have respective combinations of grit sizes of the abrasive materials.
